(19) United States
(12) Patent Application Publication
(10) Pub. No.: US 2004/0137203 A1
(43) Pub. Date: Jul. 15, 2004

(54) Method for direct parts marking composite materials

(76) Inventors: Matthew T. Adams, Mason, OH (US); Glenn David Aspenns, Cincinnati, OH (US)

Correspondence Address: ORUM & ROTH, 53 W. JACKSON BLVD, CHICAGO, IL, 60604, US

(21) Appl. No.: 10/690,370

(22) Filed: Oct. 21, 2003

Related U.S. Application Data
(63) Continuation-in-part of application No. 10/622,559, filed on Jul. 18, 2003.
(60) Provisional application No. 60/397,457, filed on Jul. 18, 2002.

(51) Int. Cl. B32B 1/00

(52) U.S. Cl. 428/195.1; 428/67

(57) ABSTRACT

An integral label for composite materials. The label, printed with magnetically doped ink, ink with UV components, ink with IR components may be embedded on the surface of the composite material using a heat curable resin. The indicia on the label can be read with magnetic ink character recognition (MICR) or other magnetic scanning technology or scanners that recognize UV and/or IR components. The label may be made of retro reflective material and reverse printed with opaque ink. The data carrier may be a mesh, paper, porous material, solid resin sheet or the data may be printed directly on the composite. There is no need for visual contrast between the composite, label and/or indicia.

This application is a continuation-in-part of U.S. Application Ser. No. 10/622559 filed Jul. 18, 2003 that claimed the benefit of U.S. Provisional Application No. 60/397457 filed Jul. 18, 2002 and incorporated herein in its entirety.

### FIELD OF THE INVENTION

This invention relates to embedded labels and barcodes. Specifically, this invention relates to hidden embedded labels and barcodes for dark-colored composite materials.

### DESCRIPTION OF RELATED ART

Direct marking of dark-colored composite materials such as Kevlar, fiberglass, carbon fiber, etc. is difficult for several reasons. First, the data carrier must be very thin and porous to avoid affecting the functionality of the part to be marked. Second, the data carrier must be relatively simple to use. Third, in some applications the color of the embedded data carrier must blend into the color of the part. In these situations, high contrast between the indicia and/or carrier and the composite is not desired. In other applications, a hidden or unobservable data carrier is required. This invention eliminates the problems that existing data carriers have with these issues.

One prior art method of making composites is to embed printed fabric into light colored composite materials as a means of marking them for identification purposes. This process involves the encapsulation of a white typewriter-printed fabric within a heat-curable resin on the surface of the item being marked. This method of marking items requires a visible marker, something that is undesirable in some applications. Further, because the method requires a visible marker it does not provide a means of marking dark-colored composite materials such as graphite, Kevlar, and carbon fiber with concealed or unobservable data carrier and/or data.

Another prior art method of marking parts (typically dark-colored fiberglass, Kevlar, or carbon-fiber) is to coat the part with a thermally curable liquid resin 32 that will be baked at high temperature to reinforce and protect the composite part. Before the resin is cured, the prior art data carrier printed with indicia 30 is placed onto the liquid resin 32, adhering the data carrier to the part 34. Following attachment of the data carrier, a second coating of liquid resin is applied 36 over the data carrier. The layering of the resin below and above the data carrier provides a means of embedding the data carrier into the object, thus acting like a direct mark for the part.

The prior art data carrier is a white mesh that is printed 30 using a positive format with text, a 2D data matrix machine-readable symbol and/or other indicia. The data carrier is printed using a dot matrix printer. The data carrier is applied to the surface of a white part 34 wetted with a thermally curable substance 32 (i.e. epoxy, etc.) Then the data carrier is coated with the same thermally curable substance 36. Once properly covered, it is passed through a dryer to cure 38, sealing the data carrier into the part itself.

With a white data carrier produced in a positive format, it can only be embedded into white-colored parts without being obvious from a distance. To be used on dark-colored parts, the image would need to be printed in a reverse format (white image on a black background). Since the prior art data carriers are printed using a standard dot matrix printer, the density of the black background will not be high enough to achieve enough contrast for the symbol to be machine readable, and will not be black enough to be non-obvious from a distance. As a result, prior art data carriers are only being used for white colored items. Furthermore, the inks used for prior art data carriers for use on dark-colored items needs to be extremely fade resistant. A reverse image printed with a dot matrix printer does not have a high enough resistance to fading. There is no need for a data carrier that can be used on dark colored composites without being readily observed.

Typically, customers purchase the data carrier in wide widths and slits it down into thinner strips that are then fed into the dot matrix printer. After printing, the strip is cut manually and then used in the embedding process. There is a need for a simpler process.

Existing data carriers are limited in two major ways. First, the resolution achievable with the data carrier is significantly reduced because it is printed using a dot matrix printer technology. This limits the size of the mark that can be produced an still be machine-readable. As a result, the size of the part that can be marked is also limited because a certain amount of area is required to hold the data carrier. Second, the dot matrix printed can only produce a positive formatted image (black on white). When trying to print a reverse image, the density of the black portion of the printed image is not high enough to achieve the required contrast for the symbol to be machine-readable.

### SUMMARY OF THE INVENTION

This invention will provide a means of creating concealed or unobservable data carriers and/or data for marking composite parts. Technology has been developed that is capable of decoding machine-readable indicia, codes, and/or symbols that are magnetically charged, even through non-metallic visual obstructions. This technology is used for decoding composite parts marked using an embedding process. Other non-pigmented inks can be used as well. Inks with a UV or IR component. A retro reflective carrier with an reverse printed symbol could also be used.

There is a need for a means of directly marking dark colored composite materials. Accordingly, one object of the present invention is to provide a method for direct marking of dark colored composite materials, such as Kevlar, fiberglass, and carbon fiber. There is also a need for a means of marking composite materials for identification that will not effect the functionality of the part. Accordingly, it is another object of the present invention to provide a means for marking composite material that does not affect the functionality of the part and which is simple to use.

There is a need for a means of marking composite materials for identification in which the identifying marker is hidden or invisible. This is useful for security, national defense, or other similar uses. Accordingly, it is an object of the present invention to provide a means for marking composite materials for identification in which the marker is hidden or invisible.

### BRIEF DESCRIPTION OF THE DRAWINGS

FIG. 1 is a schematic representation of an expanded cross section of a composite material with an embedded barcode.

FIG. 2 is a schematic representation of an expanded cross section of a composite material with an alternative embodiment of the present invention.

FIG. 3 is an alternative schematic representation of an embedded data carrier.

FIG. 4 is a flow chart of a method of embedding a data carrier.

FIG. 5 is a cut-away view of a container with an alternative embodiment of the present invention.

FIG. 6 is a cut-away view of a container with an object with an integral label.

FIG. 7 is a bar code.

FIG. 8 is a reverse printed bar code.

FIG. 9 is a prior art data carrier.

FIG. 10 is a scanner and an embedded data carrier.

### DETAILED DESCRIPTION OF THE INVENTION

Magnetic ink character recognition (MICR), uses a reader that can discern characters printed onto non-magnetic materials using magnetic ink in much the same manner as optical character recognition (OCR) scanners use contrast between the black image and the white paper to discern the characters. MICR is used to print the account numbers on the bottom of checks to make them easily scanned. Similar magnetic imaging technology will allow persons to scan machine-readable bar codes. This ability to use non-optical means for identification solves issues related to marking dark-colored composite materials. Other scanners can capture images that fluoresce when exposed to UV or IR light. Because the scanners read the magnetized, IR or UV ink, there is no need for any visual contrast between the ink, carrier and/or object. On dark colored composites, a dark colored carrier with dark indicia is often preferred to minimize or eliminate any visible marks indicating a label.

This present invention involves the printing of a porous woven mesh with ink that has magnetic, UV, or IR components incorporated into it. The porous mesh works for embedding because it is thin and porous, allowing surrounding composite material to flow into the pores and bond with the mesh.

Composite materials are typically formed from at least one reinforcing material and a matrix. The reinforcing material may be, for example, fiber, particulate, or a laminate. Matrix materials may be, for example, ceramic or polymers. Through the selection of variables such as reinforcing material(s), matrix material, composition and reinforcement arrangement composites with a wide range of properties have been developed. Common composite materials are glass-polymer, graphite-polymer, kevlar-epoxy, kevlar-polyester and carbon-carbon composites. Polymer and ceramic matrix composites are widely used, for example, in automotive, marine, aircraft, and aerospace components. They are also used in sporting goods, such as tennis rackets, skis, and fishing rods.

One embodiment of the present invention uses magnetic ink. Because the ink is easily magnetizeable it is preferable that the composite be made of a non-magnetic matrix and non-magnetic reinforcement material. Alternatively, the data carrier can be made of a material that absorbs UV and/or IR light an ink containing UV and/or IR components can be used. In yet another embodiment, the ink could contain a component that absorbs energy in the IR range of the spectrum. This is commonly done for thermal media used in medical applications. The ink printed onto the mesh could be doped with this IR absorbing material.

Then a scanner 28 could be used that emits energy in this IR range and detects the signal received back from the image. The ink can be pigmented if it is not necessary or desirable to hide the data or unpigmented ink can be used when the data is to be hidden.

An alternative embodiment uses a phosphorescent clear ink that would be visible when viewed under a black light. The scanner 28 can be modified so that it scans at the same wavelength as the black light. In doing so, the security of the symbol could be maintained and the use of counterfeit items could be prevented.

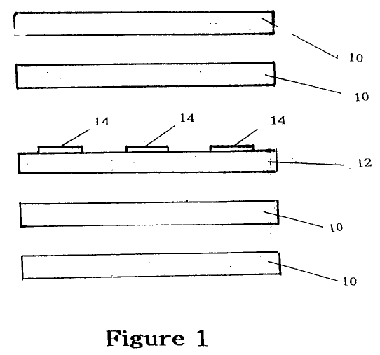

Referring to FIG. 1 a composite material with an embedded barcode is shown. The composite material consists of a plurality of layers of composite material 10. Sandwiched between two of the layers of composite material 10 is a data carrier 12. Indicia 14 is printed on one surface of the data carrier 12. Preferably, the printed indicia 14 is printed using magnetically doped ink. Preferably, the data carrier 12 is a mesh. More preferably, the data carrier 12 is porous woven mesh. Most preferably, the data carrier 12 is a porous woven mesh that is very thin and porous. The porous woven mesh allows the matrix material of the composite material 10 to flow into the fabric thus bonding the wet mesh with the composite material 10. Alternatively, the data carrier can be paper or other porous material that accepts printing and allows permeation by the resin. In yet another embodiment, a sheet of solid resin material can be used as the data carrier. The resin accepts printing, and would bond with the liquid resin to form a solid layer of resin, but would retain the printed image. In yet another embodiment, the data is printed directly on the composite material and builds it into the item using the resin. The data may be printed using transfer, screen printing, flexographic printing, hot stamp, etc or other known printing methods.

The data carrier is printed with the appropriate indicia 14. The indicia 14 may be any suitable text, a symbol, bar code, logo or other indication. In the preferred embodiment of the present invention, the indicia 14 is a bar code. The indicia 14 may be printed using an ink that has magnetic characteristics such as magnetically doped ink. Alternatively, the indicia can be printed using ink with UV or IR components, such as ink that fluoresces under IR or UV light. The indicia need not have any visible contrast with the mesh and/or composite.

The mesh is embedded between layers of composite material 10. Typically, a product made of composite material 10 such as Kevlar, carbon fiber and fiberglass is manufactured by laminating a plurality of layers of the composite material 10 together. The data carrier is sandwiched between layers of composite material 10. The data carrier 12 with magnetic ink indicia is embedded between the layers of a composite material 10 during construction of the product. When the construction is completed, a scanner using MICR or similar technology is able to read the label through the composite material 10. Since the scanner only discerns the magnetic ink, the multiple layers of composite material 10 between the scanner and the data carrier 12 appear invisible to the scanner. Furthermore, the embedded data carrier 12 will not result in any visually discernable marks, effectively concealing the data and its location.

By way of one example, the nose cone of a jet aircraft is manufactured from carbon fiber that is black in color. The cone is manufactured by laminating many sheets of carbon fiber on top of one another resulting in a cone with extremely high strength properties. Porous woven mesh is printed with an identification marker using magnetically doped ink. During construction of the cone, the printed mesh is placed between two of the carbon fiber sheets used to construct the cone. The printed mesh, located between two of the carbon fiber sheets, is constructed into the cone. The marker is read through the cone.

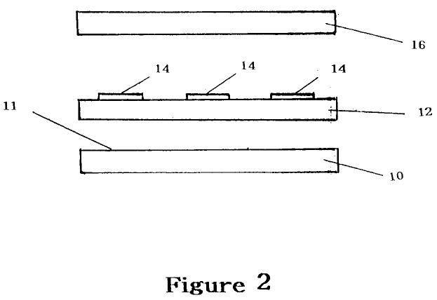

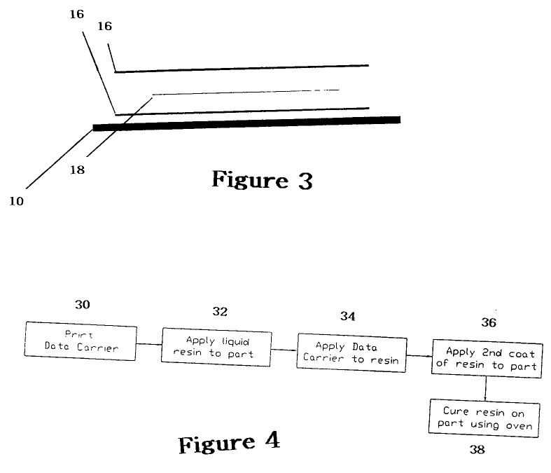

Referring to FIG. 2, another embodiment of the present invention is shown. The printed mesh 12 will be embedded in or on the surface 11 of the composite 10 using a heat-curable, resin material. The composite material 10 can be particulate, laminar, chopped fiber, unidirectional or other known composite type. The resin material 16 is preferably selected based on the composite. The preferred resin material is a liquid heat-curable resin. Preferably, the data carrier 12 with printed indicia 14 is placed on the composite 10 during the manufacturing process and the mesh carrier is coated with the heat curable resin 16. Alternatively, the printed mesh carrier 12 is placed on the composite 10 after the composite has been manufactured. The resin 16 is then coated over the mesh 10. The part is then thermally cured by baking at a high temperature to reinforce and protect the composite part. Before the resin is cured, the data carrier is placed onto the liquid resin, basically adhering the data carrier to the part. Following attachment of the data carrier, a second coating of liquid resin is applied over the data carrier. The layering of the resin below and above the data carrier provides a means of embedding the data carrier into the object, thus acting like a direct mark for the part. Once properly covered, it is passed through a dryer to cure, sealing the data carrier into the part itself. Preferably, the ink has magnetic, UV or IR components. The ink can be pigmented if contrast with the data carrier or composite substrate is desired. However, unpigmented ink is preferred.

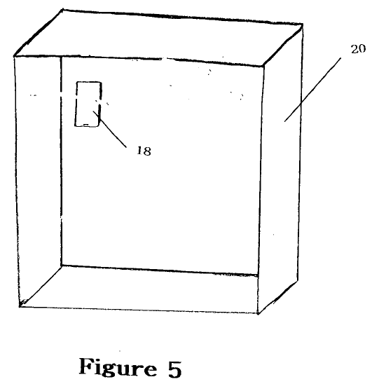

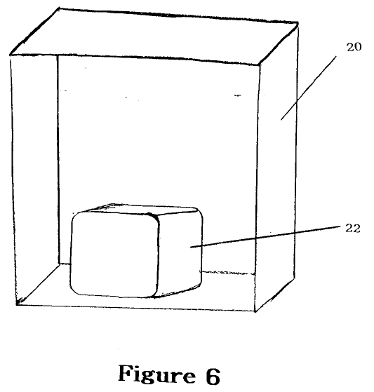

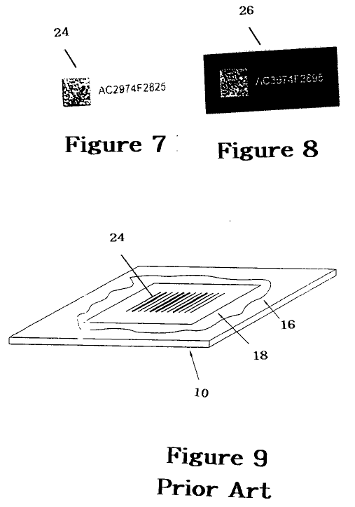

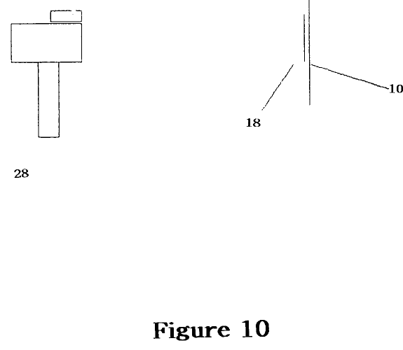

Referring now to FIG. 5, another embodiment of the present invention is shown. A standard label 18 is printed using ink with magnetic characteristics, preferably, magnetically doped ink. The printed label or stencil 18 maybe placed on the inside of the container 20 and sealed within the container 20. The indicia does not need to have any visual contrast with the label. It may be desirable in some situations to have visual contrast, so that the label can be read using other methods such as by a person or OCR scanner once the container is opened or before it is closed. As shown in FIG. 6, a composite object 22 such as a automotive, aerospace, marine, or aircraft part, having an integral label can be placed inside a container 20. The label can read through the container 22 wall.

An alternative embodiment uses a retro reflective mesh in conjunction with opaque ink. The ink would be printed in reverse-video so that the retro reflective mesh is hidden except in the region where the bar code elements are located. When a laser scanner beam impinges on the non-printed regions of the reverse printed bar code 26, the mesh magnifies and reflects the laser signal back to the scanner. The retro reflective mesh in combination with the printed ink provides the contrast required to decode the symbol. Alternatively, a light colored mesh could be reverse printed for applications where having hidden indicia is not critical.

A thermal transfer ribbon may be used to print a standard 24 or reversed image 26 onto a mesh substrate that is used as the data carrier for a dark-colored item. The color of the mesh is preferably white or yellow and when printed with the black thermal transfer ribbon provides enough contrast for a machine-readable symbol while appearing non-obvious from a distance. The thermal ribbon and mesh are engineered together so that the maximum resolution exceeds the ability to print a data matrix 2D machine readable symbol containing 200 characters of data within a symbol that is smaller that 0.4 inches on a side. This construction also provides for significantly improved resolution for the white-colored parts by simply printing in a positive format rather than a reverse format. The inks are formulated with black pigments that are highly resistant to image fade.

In addition to the higher resolution, the inventive data carrier provides a high level of ease of use. The inventive construction is supplied in printer-compatible rolls. The rolls can be loaded into a thermal printer along with the appropriate ribbon and the data carrier will be printed with the appropriate information and then automatically cut using a standard cutter accessory.

This provides the customer with a data carrier that is printed on-demand with variable data in a singulated form ready for embedding.

The inventive data carrier may be constructed from a light-colored mesh material (such as white, yellow, or similar light colors) that will be printed using a specially designed thermal transfer ribbon. This data carrier preferably has a uniform surface that maximizes the print resolution of the image. This uniformity is achieved by using a plain-weave construction in a high thread count construction. If the item to be marked is going to be embedded into a light-colored part, the image will be printed in a positive format 24 so that the data carrier is non-obvious when looking at the part. If the item to be marked is dark-colored, the data carrier will be printed in a reverse format (white on black) 26 so that the data carrier is non-obvious when observing the part.

This new data carrier will also provide significantly higher resolution than the existing data carrier. A thermal printer is using to print the data carrier. This higher resolution provides two advantages. First, a smaller machine-readable symbol can be produced, increasing this embedding process to be used on smaller parts. Second, the higher resolution will provide a means to encode significantly more data into the symbol without increasing its size. The inventive construction also provides greater ease of use. The data carrier mesh is printed using the thermal ribbon and is cut using a standard cutter. Producing the data carriers in this fashion provides a means of creating an on-demand data carrier that has been singulated for use in the embedding process.

1. A label for use with a composite material comprising:
a carrier with ink indicia, the ink is selected from the group consisting of ink with magnetic components, ink with IR components and ink with UV components;
wherein the label is integral with an object comprised of a composite material.

2. The label of claim 1, wherein the carrier is selected from the group consisting of a mesh, paper, a porous material that is printable and allows permeation of a resin material, and a sheet of solid resin material.

3. The label of claim 1, wherein the object is free of any visually discernable marks indicating the label.

4. The label of claim 1 wherein the ink is unpigmented.

5. The label of claim 1, wherein the object is selected from the group consisting of:
automotive component, aerospace component, marine component, and aircraft component.

6. The label of claim 1, wherein the label is embedded in the surface of the composite material using a resin material.

7. The label of claim 7, wherein the carrier is selected from the group consisting of a mesh, paper, a porous material that is printable and allows permeation of a resin material, and a sheet of solid resin material, a mesh.

8. The label of claim 5, wherein the object is free of any visually discernable marks indicating the label.

9. A label for use with a composite material comprising:
a carrier with ink indicia printed in reverse,
wherein the label is integral with an object comprised of the composite material.

10. The label of claim 9 wherein the carrier is a retro reflective mesh and the ink obscures the retro reflective mesh except for the indicia.

11. A method of concealing data comprising the steps of:
obtaining a carrier;
printing data on the carrier with ink selected from the group consisting of magnetically doped ink, ink with UV components, ink with IR components; and
embedding the carrier in a composite material.

12. The method of claim 11 wherein the carrier is selected from the group consisting of a mesh, paper, a porous material that is printable and allows permeation of a resin material, and a sheet of solid resin material.

13. The method of claim 11 further comprising the steps of:
placing the carrier on the surface of the composite;
coating the carrier with a resin;
allowing the resin to flow into the carrier; and
bonding the carrier to the composite material.

14. The method of claim 11 wherein the composite material is manufactured into an object, said object is selected from the group consisting of:
automotive component, aerospace component, marine component, and aircraft component.

15. A method of concealing data comprising the steps of:
obtaining a retro reflective data carrier;
printing indicia on the data carrier to obscure the retro reflective data carrier except for the indicia; and
embedding the carrier into a composite material.

16. The method of claim 15 further comprising the steps of:
placing the carrier on the surface of the composite material;
coating the carrier with a resin;
allowing the resin to flow into the carrier; and
bonding the carrier to the composite material.

17. The method of claim 15 wherein the composite material is manufactured into an object, said object is selected from the group consisting of:
automotive component, aerospace component, marine component, and aircraft component.

18. A method of concealing data comprising the steps of:
printing data on a composite with ink, said ink selected from the group consisting of magnetically doped ink, ink with UV components, and ink with IR components.

19. The method of claim 18 wherein the composite is manufactured into an object, said object is selected from the group consisting of:
automotive component, aerospace component, marine component, and aircraft component.
